(19) United States
(12) Patent Application Publication
(10) Pub. No.: US 2015/0128464 A1
(43) Pub. Date: May 14, 2015

(54) SIGN DISPLAY

(71) Applicant: Albert O. JONES, III, Memphis, TN (US)

(72) Inventor: Albert O. JONES, III, Memphis, TN (US)

(21) Appl. No.: 14/540,314

(22) Filed: Nov. 13, 2014

Related U.S. Application Data
(60) Provisional application No. 61/903,747, filed on Nov. 13, 2013.

(51) Int. Cl. G09F 21/04; G09F 7/18

(52) U.S. Cl. CPC G09F 21/04; G09F 7/18; G09F 2007/1843; G09F 2007/1865
USPC 40/594; 40/606.01; 29/525.08

(57) ABSTRACT

A display fastener is provided. The display fastener embodies a releasably attachable sign display for various interchangeable signs. The display fastener may provide a body sheet of design material forming an attachment plate and a fastener configuration on opposing ends thereof. The attachment plate may provide a sign fastener. The fastener configuration forms a slide-in region, a reception pocket and a tension clip communicating therebetween, wherein the tension clip is positionable in a tension-biased position and an opened position communicating the slide-in region to the reception pocket.

### CROSS-REFERENCE TO RELATED APPLICATION

This application claims the benefit of priority of U.S. provisional application number 61903747, filed Nov. 13, 2013, the contents of which are herein incorporated by reference.

### BACKGROUND OF THE INVENTION

The present invention relates to sign displays and, more particularly, to a sign display fastener releasably attachable to a vehicle.

Generally, people would like to support causes or organizations by displaying such support on their vehicle, mostly through some form of sign, like a decal or a bumper sticker. These methods, however, are almost impossible to get off without damaging the vehicle's paint job. As a result, many people leave them on for the life of the vehicle. This can decrease the re-sale value and overall look of the vehicle. And so many people choose not to put any adhesive signs on their vehicle because of the mess and hassle of getting it off (such as buying and using removal products that cost more the sign).

Magnet sign displays and magnetic sign display systems may be releasably attachable, but the magnetic sign displays tend to fade after a short time and are more expensive then the adhesive sign, and the magnetic sign display systems (such as magnetic pockets) cannot easily be adapted to accommodate various shapes and sizes of signs.

As can be seen, there is a need for a device for displaying various pictures and messages from a vehicle that is reusable and easily to remove without a mess.

### SUMMARY OF THE INVENTION

In one aspect of the present invention, releasably attachable sign display for various interchangeable signs comprises: a body sheet comprising a design material, wherein the body sheet forms an attachment plate and a fastener configuration on opposing ends thereof, wherein the attachment plate provides a sign fastener, wherein the fastener configuration forms a slide-in region, a reception pocket and a tension clip communicating therebetween, and wherein the tension clip is positionable in a tension-biased position and an opened position communicating the slide-in region to the reception pocket.

In another aspect of the present invention, a method of placing a display on a vehicle comprises: providing a releasably attachable sign display for various interchangeable signs comprising: a body sheet comprising a design material, wherein the body sheet forms an attachment plate and a fastener configuration on opposing ends thereof, wherein the attachment plate provides a sign fastener, wherein the fastener configuration forms a slide-in region, a reception pocket and a tension clip communicating therebetween, and wherein the tension clip is positionable in a tension-biased position and an opened position communicating the slide-in region to the reception pocket; placing a sign comprising at least one message on the sign fastener; urging the tension clip in the opened position; sliding a portion of the vehicle into the reception pocket; and positioning the tension clip in the tension-biased position.

In yet another aspect of the present invention, releasably attachable sign display for various interchangeable signs, comprising: a body sheet comprising a design material, wherein the body sheet forms an angled arm interconnecting an attachment plate and an opposing fastener configuration, wherein the attachment plate provides double-sided tape, wherein the fastener configuration extends to form a slide-in region, a reception pocket, a tension clip communicating between the slide-in region and the reception pocket, and terminates in a slanted leg, wherein the slanted leg defines a portion of the slide-in region, wherein the tension clip is positionable in a tension-biased position and an opened position communicating the slide-in region to the reception pocket, and wherein a protective coating is provided over a portion of the body sheet.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a detail perspective view of an exemplary embodiment of the present invention, shown in use;

FIG. 3 is a perspective view of an exemplary embodiment of the present invention;

FIG. 4 is a rear perspective view of an exemplary embodiment of the present invention;

FIG. 5 is a front view of an exemplary embodiment of the present invention;

FIG. 6 is a side view of an exemplary embodiment of the present invention;

FIG. 7 is an exploded view of an exemplary embodiment of the present invention, demonstrating application thereof;

FIG. 8 is a perspective view of an exemplary embodiment of the present invention; demonstrating post-application thereof;

FIG. 9 is a detailed perspective view of an exemplary embodiment of the present invention, shown in use; and

FIG. 10 is a section detail view of an exemplary embodiment of the present invention, taken along line 10-10 in FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a display fastener embodying a releasably attachable sign display for various interchangeable signs. The display fastener may provide a body sheet of design material forming an attachment plate and a fastener configuration on opposing ends thereof. The attachment plate may provide a sign fastener. The fastener configuration forms a slide-in region, a reception pocket and a tension clip communicating therebetween, wherein the tension clip is positionable in a tension-biased position and an opened position communicating the slide-in region to the reception pocket.

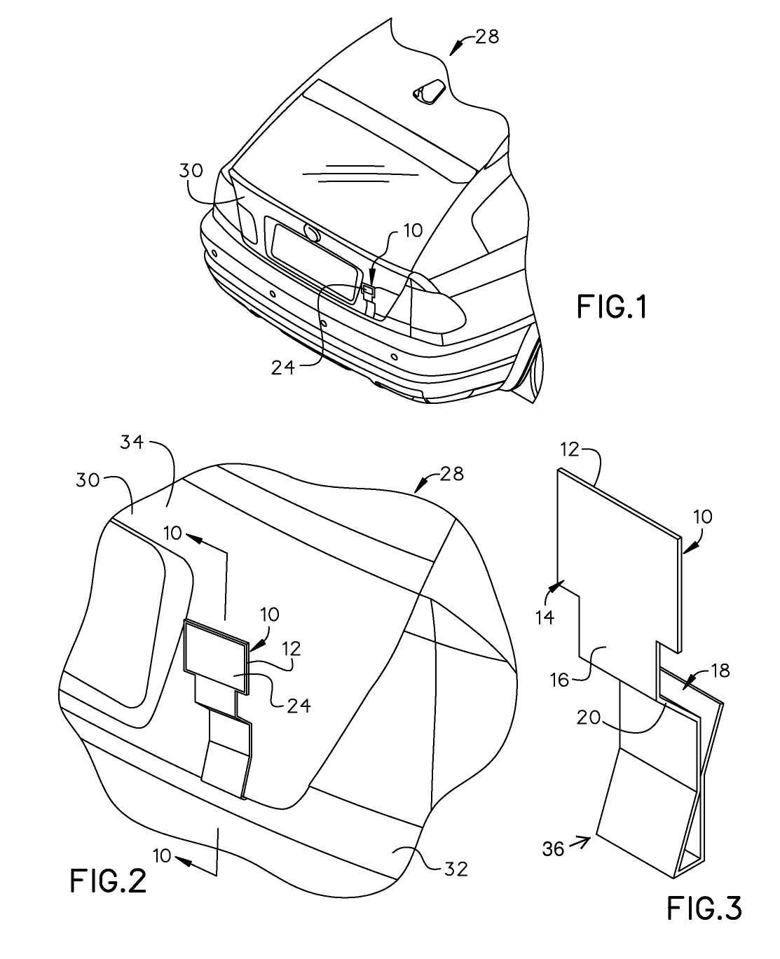

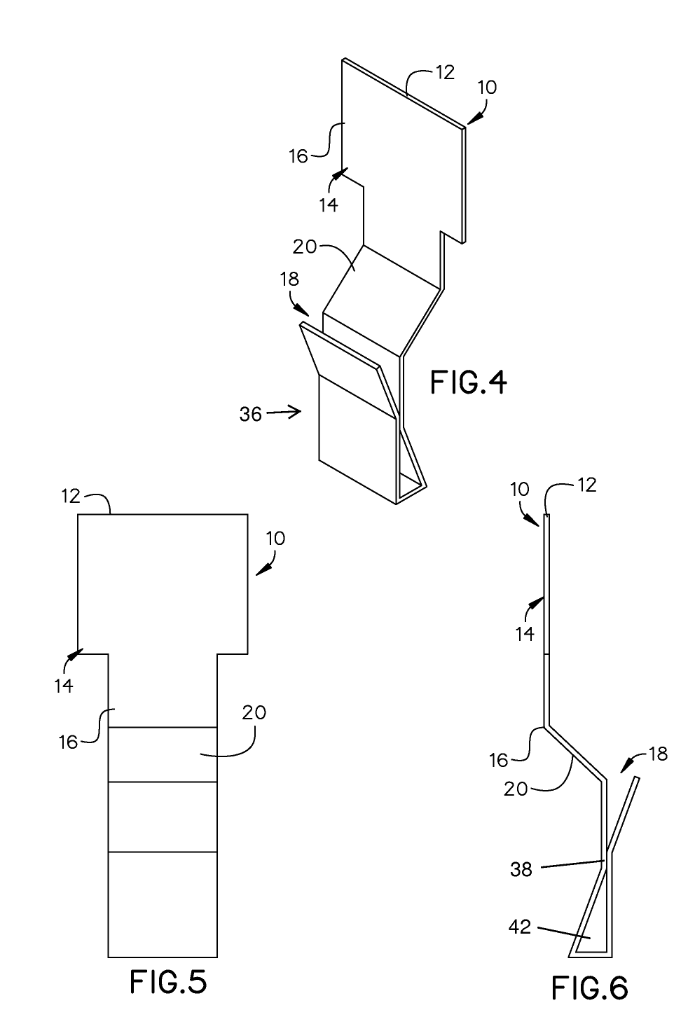

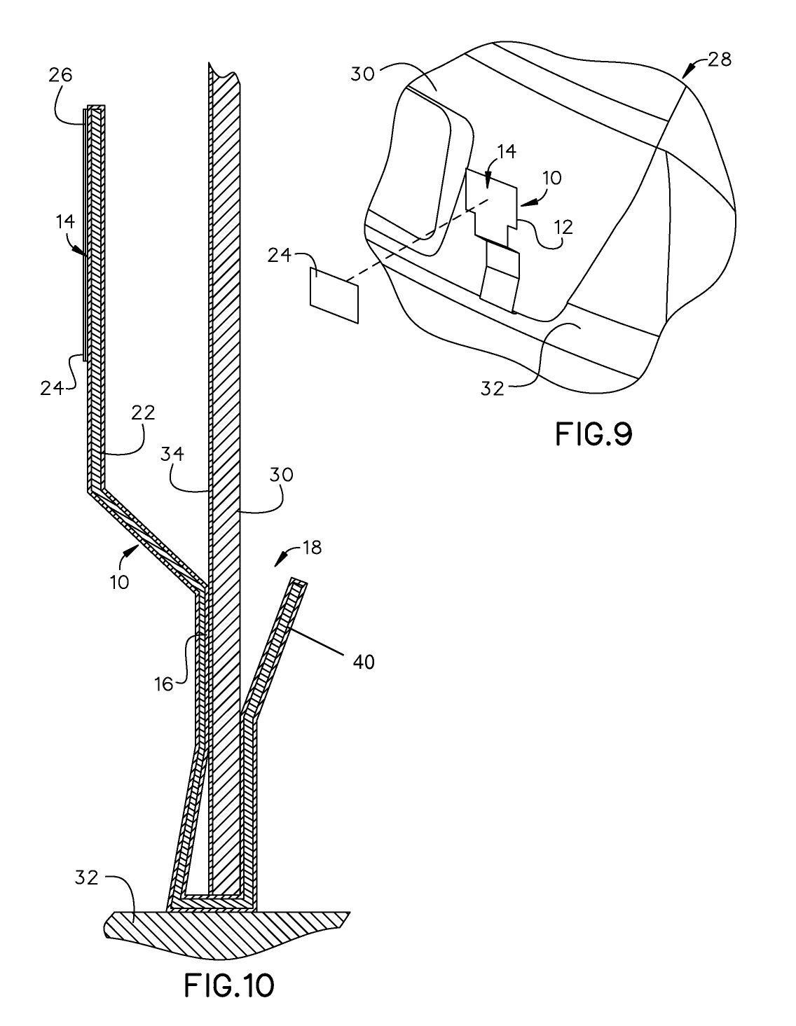

Referring to FIGS. 1 through 10, the present invention may include a display fastener 10 for displaying a sign 24 from a vehicle 28. The display fastener 10 may include a body sheet 16 made of an design material 22 that can be repeatedly bent without fracturing, such as various metallic or blended metallic materials, polyethylene, polypropylene, vinyl, nylon, rubber, various impregnated or laminated fibrous materials, various plasticized materials and the like. The body sheet 16 may be made from a unitary sheet of the design material 22. The body sheet 16 may provide a protective coating surrounding at least a portion of the design material 22, wherein the protective coating may be adapted to protect the paint 34 of the vehicle 28, such as cloth, rubber, plastic, and the like.

The body sheet 16 may form an angled arm 20 interconnecting an attachment plate 12 and a fastener configuration 36, as illustrated FIGS. 3 through 6.

The attachment plate 12 may define an attachment surface 14 for displaying a sign 24. The attachment plate 14 may provide a sign fastener 26 for removably securing the sign 24 thereto, as illustrated in FIG. 10. It should be understood that the sign fastener 26 may be any fastener known in the art for fastening or removably securing one object to another including, for example, standard bracket clamps, magnets, Velcro-type fasteners, adhesive substances, combinations thereof, and the like, so long as the sign fastener 26 functions in accordance with the present invention as described herein. In certain embodiments, the adhesive substances may be double-sided tape.

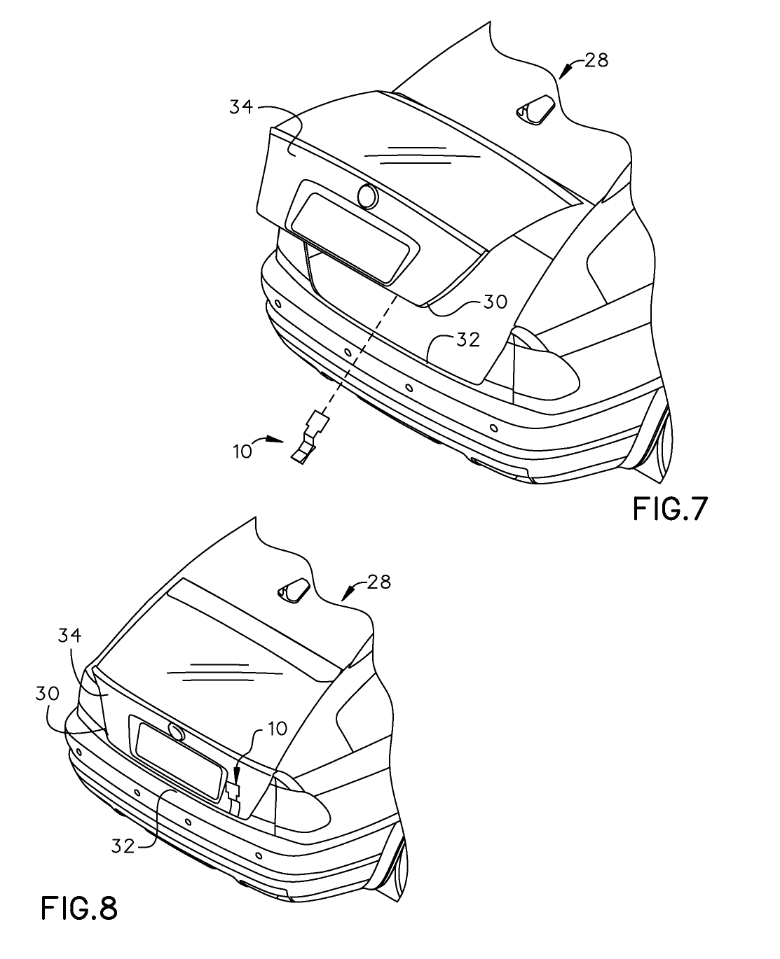

A portion of the body sheet 16 may provide the fastener configuration 36 by forming a U-shape that turns back into itself at a rear portion, as illustrated in FIGS. 6 and 10. The rear portion of the U-shape may provide a slanted leg 40 defining a slide-in region 18. A proximal portion of the slanted leg 40 may extend to a portion of the body sheet 16 so as to form a tension clip 38, as illustrated in FIG. 6. The tension clip 38 may be positionable in an opened position and a tension-biased position for removably securing to an object 32. The slide-in region 18 may communicate to the tension clip 38 in the tension-biased position and a reception pocket 42 in the opened position. In the opened position the object 32 can be received into the reception pocket 42. The object 32 may include but not limited to a rim of a trunk hatch 30 of the vehicle 34 or other portion of the vehicle 34.

The angled arm 20 may be at a desired angle adapted to facilitate the removably securing of the object 32 and the displaying of the sign 24. The sign 24 may include, but not be limited to, print outs, bumper stickers, decorations, pictures, and anything that a user would like to display with any designs and/or messages. For example, a user may print an item from their printer on a sheet of paper and place the sheet of paper on the attachment surface 14.

A method of using the present invention may include the following. The display fastener 10 disclosed above may be provided. A user may detachably secure the sign 24 to the sign fastener 26 by, for example, taking off the adhesive cover of double-sided tape. Then the user may manipulate the slanted leg 40 so as to urge the tension clip 38 to the opened position, wherein the object 32 may be slidably received into and through the slide-in region 18 and partially into the reception pocket 42. Then the user may release the slanted leg 40 to position the tension clip 38 to the tension-biased position to releasable attach the display fastener 10 to the vehicle 28. In certain embodiments, the user may releasable attach the display fastener 10 to non-vehicular objects, including but not limited to a planar portion of a residence.

It should be understood, of course, that the foregoing relates to exemplary embodiments of the invention and that modifications may be made without departing from the spirit and scope of the invention as set forth in the following claims.

What is claimed is:

1. A releasably attachable sign display for various interchangeable signs, comprising:
a body sheet comprising a design material, wherein the body sheet forms an attachment plate and a fastener configuration on opposing ends thereof,
wherein the attachment plate provides a sign fastener,
wherein the fastener configuration forms a slide-in region, a reception pocket and a tension clip communicating therebetween, and
wherein the tension clip is positionable in a tension-biased position and an opened position communicating the slide-in region to the reception pocket.

2. The releasably attachable sign display of claim 1, wherein the sign fastener is an adhesive.

3. The releasably attachable sign display of claim 2, wherein the adhesive is double-sided tape.

4. The releasably attachable sign display of claim 1, wherein the fastener configuration further provides a slant leg defining a portion of the slide-in region.

5. The releasably attachable sign display of claim 1, wherein the sign fastener further provides an angled arm interconnecting the attachment plate and the fastener configuration.

6. The releasably attachable sign display of claim 1, wherein the body sheet is manufactured from a unitary sheet of design material.

7. The releasably attachable sign display of claim 1, further providing a protective coating over a portion of the body sheet.

8. The releasably attachable sign display of claim 1, wherein the portion of the body sheet coincides with the fastener configuration.

9. A method of placing a display on a vehicle, comprising:
providing a releasably attachable sign display for various interchangeable signs comprising: a body sheet comprising a design material, wherein the body sheet forms an attachment plate and a fastener configuration on opposing ends thereof, wherein the attachment plate provides a sign fastener, wherein the fastener configuration forms a slide-in region, a reception pocket and a tension clip communicating therebetween, and wherein the tension clip is positionable in a tension-biased position and an opened position communicating the slide-in region to the reception pocket;
placing a sign comprising at least one message on the sign fastener;
urging the tension clip in the opened position;
sliding a portion of the vehicle into the reception pocket; and
positioning the tension clip in the tension-biased position.

10. A releasably attachable sign display for various interchangeable signs, comprising:
a body sheet comprising a design material, wherein the body sheet forms an angled arm interconnecting an attachment plate and an opposing fastener configuration,
wherein the attachment plate provides double-sided tape,
wherein the fastener configuration extends to form a slide-in region, a reception pocket, a tension clip communicating between the slide-in region and the reception pocket, and terminates in a slanted leg, wherein the slanted leg defines a portion of the slide-in region,
wherein the tension clip is positionable in a tension-biased position and an opened position communicating the slide-in region to the reception pocket, and
wherein a protective coating is provided over a portion of the body sheet.
